(19) United States
(12) Patent Application Publication
(10) Pub. No.: US 2004/0064430 A1
(43) Pub. Date: Apr. 1, 2004

(54) Systems and methods for queuing data

(76) Inventors: Jonathan D. Klein, Redwood City, CA (US); Amit Ganesh, San Jose, CA (US); Chi Young Ku, San Ramon, CA (US); Ari W. Mozes, San Carlos, CA (US)

Correspondence Address: Peter C. Mel, Bingham McCutchen LLP, Three Embarcadero Center, Suite 1800, San Francisco, CA, 94111-4067, US

(21) Appl. No.: 10/259,369

(22) Filed: Sep. 27, 2002

(51) Int. Cl. G06F 7/00

(52) U.S. Cl. 707/1

(57) ABSTRACT

A container object data structure for storing metadata associated with multiple queues is provided for processing data elements in first-in, first-out fashion. In one embodiment, the container object is implemented in a database environment providing statement syntax for creating data objects, such as tables and views, to implement user schema. Queue metadata can comprise one or more pointers for data element access and control during one or more queue operations, such as an enqueue, dequeue, or update operation.

### FIELD OF THE INVENTION

This application relates generally to computer data structures, and more particularly relates to systems and methods for queuing data.

### BACKGROUND AND SUMMARY

In a typical two-tier database management systems (DBMS) architecture, a client issues a database statement to a process running on the database server through a proprietary or open-system call level interface. The server processes the client's request, including creating, updating, and deleting elements within database objects (i.e., tables and views) in order to effectuate the user's schema. Processes running on the server must perform operations efficiently in order to effectively service the client, and also to stay competitive in the DBMS marketplace.

The data structures used to implement and maintain database objects are key to efficient processing and system performance, and can translate directly into cost savings for the organization. Not all database processing environments are the same; hence, it is desirable for statement processing to be engineered to meet the demands of a particular run-time environment. For example, the performance needs of a typical analytical processing environment, where queries are largely issued ad-hoc, are very different from the exacting requirements demanded of an “always on” online transaction processing (OLTP) application. Designers and DBAs alike need the tools and flexibility to build systems that offer customers and end-users a broad choice of options to meet a variety of system constraints.

System performance depends in large part upon the underlying data structures used to implement the abstract data types called for in a design. Because database clients frequently ask a server to process data in non-serial fashion, some data structures are better suited than others for building such objects as indexes and tables. Binary trees, for instance, are ideal for implementing an index because of the advantages offered by these data structures in facilitating searching. However, for some OLTP systems where the data is processed sequentially or nearly sequentially, the use of these data structures can limit performance, depriving the system of a performance advantage that might otherwise be available had a more streamlined data structure been employed.

The systems and methods for queuing data, according to embodiments of the invention, overcome the disadvantages of current data structures by exploiting the performance advantages of a queue data structure in those instances where sequential (i.e., first-in, first-out) processing of data elements is contemplated, such as in certain benchmark standards. In one embodiment, a queuing system designed in accordance with an embodiment of the invention comprises queue metadata for storing such items as pointers needed to carry out queue operations, such as enqueue, dequeue, and update operations.

In another embodiment, a method for queuing data comprises a container object, such as a hash table, for storing queue metadata for multiple queues. In another embodiment, a database implementation of the systems and methods herein described is contemplated, facilitating database statement creation and manipulation of data objects, such as tables, in accordance with one or more user schemas.

The systems and methods for queuing data reap many benefits, including enhanced database statement processing performance in constant average time. Further details of aspects, objects, and advantages of the invention are described in the detailed description, drawings, and claims.

### BRIEF DESCRIPTION OF THE DRAWINGS

FIG. 1 is a block diagram representing a queue abstract data type according to the prior art.

FIG. 2 is a block diagram of a queue implemented using a linked list according to the prior art.

FIG. 3 is a block diagram of a linked list queue and queue metadata implemented in accordance with an embodiment of the invention.

FIG. 4 is a block diagram illustrating an enqueue operation in accordance with an embodiment of the invention.

FIG. 5 is a block diagram illustrating a dequeue operation in accordance with an embodiment of the invention.

FIG. 6 is a block diagram of a container object for containing queue metadata for multiple queues in accordance with an embodiment of the invention.

FIG. 7 is a flow diagram illustrating one example enqueue operation in accordance with an embodiment of the invention, as introduced with respect to FIG. 4.

FIG. 8 is a flow diagram illustrating one example dequeue operation in accordance with an embodiment of the invention, as introduced with respect to FIG. 5.

FIG. 9 is a flow diagram illustrating one example update operation in accordance with an embodiment of the invention.

FIG. 10 is a block diagram of an exemplary computer system that can be used in an implementation of the invention.

FIG. 11 is a block diagram of an exemplary two-tier client/server system that can be used to implement an embodiment of the invention.

### DETAILED DESCRIPTION OF THE PREFERRED EMBODIMENTS

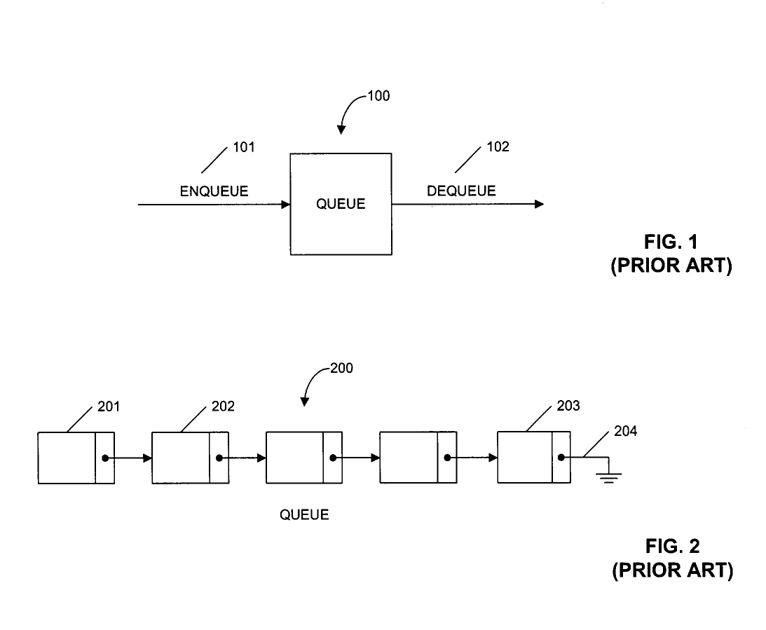

A queue is a well-known abstract data type that organizes and processes data sequentially following a scheme of first-in, first-out (FIFO). FIG. 1 characterizes a block diagram of a queue 100 depicting an enqueue operation 101 and a dequeue operation 102. The enqueue operation accepts a data element, such as a record of a SQL table, and creates a node containing the data element at the tail end of the queue. The dequeue operation removes a node from the head end of the queue, thus preserving the FIFO nature of the queue data type.

A queue may be implemented using a number of data structures, including arrays, linked lists, doubly linked lists, etc. FIG. 2 is a block diagram of a queue 200 implemented using a linked list. Head node 201 in linked list 200 contains a pointer to the next node 202 in the list. Tail node 203 represents the end of list 200, as indicated by null pointer 204. A node in a linked list can contain any variety of data elements, including a pointer to other elements. In a database context, a data element of a linked list can comprise a pointer to a relative record number of a storage block where the corresponding physical record resides.

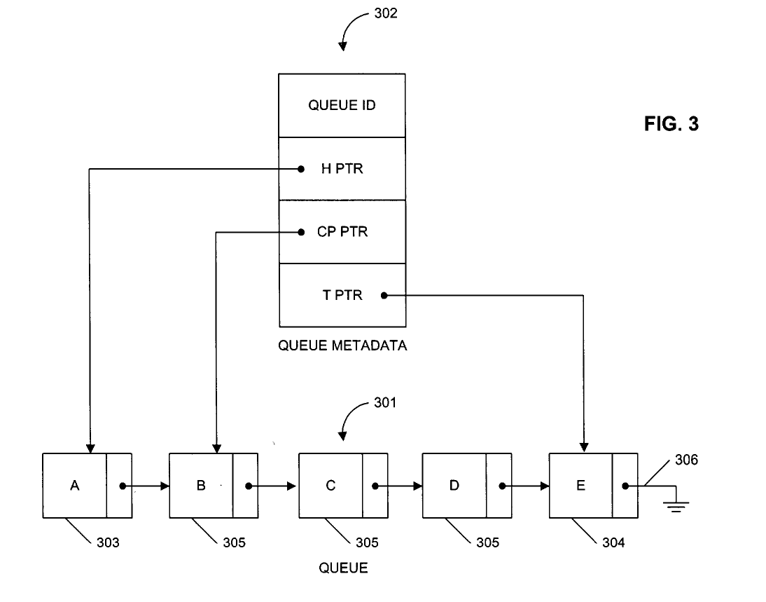

FIG. 3 is an exemplary block diagram of a linked list queue 301 and queue metadata 302 implemented in accordance with an embodiment of the invention. Queue 301 comprises head node 303, one or more intermediate nodes 305, and tail node 304. Tail node 304 terminates queue 301 with null pointer 306. Each node in queue 301 comprises both a data element, denoted A through E, and either a pointer to another node in queue 301 or the null pointer.

Queue metadata 302 is a data object external to queue 301, which comprises a queue identifier (QUEUE ID), a head pointer (H PTR), a current position pointer (CP PTR), and a tail pointer (T PTR). H PTR comprises a pointer to head node 303 and T PTR comprises a pointer to tail node 304. CP PTR comprises a pointer capable of pointing to any node in queue 301 in order to mark a location for current processing. In another embodiment, a plurality of pointers, such as an array of current position pointers, would permit queue operations to be performed at various positions along the queue—i.e., at any node pointed to by a current position pointer in the array.

Various methods can be defined and implemented to carry out queue creation and maintenance according to embodiments of the invention. For example, methods for enqueuing and dequeuing data are needed to support real-time modification to queue 301 and queue metadata 302 as nodes are added or removed. Each of H PTR, T PTR, and CP PTR can be dynamically repositioned to enable many conceivable queue operations, several of which are described in detail to follow. In both enqueue and dequeue operations, the FIFO mandate is met by dequeuing from the end of the queue opposite the end where enqueuing takes place.

Enqueue

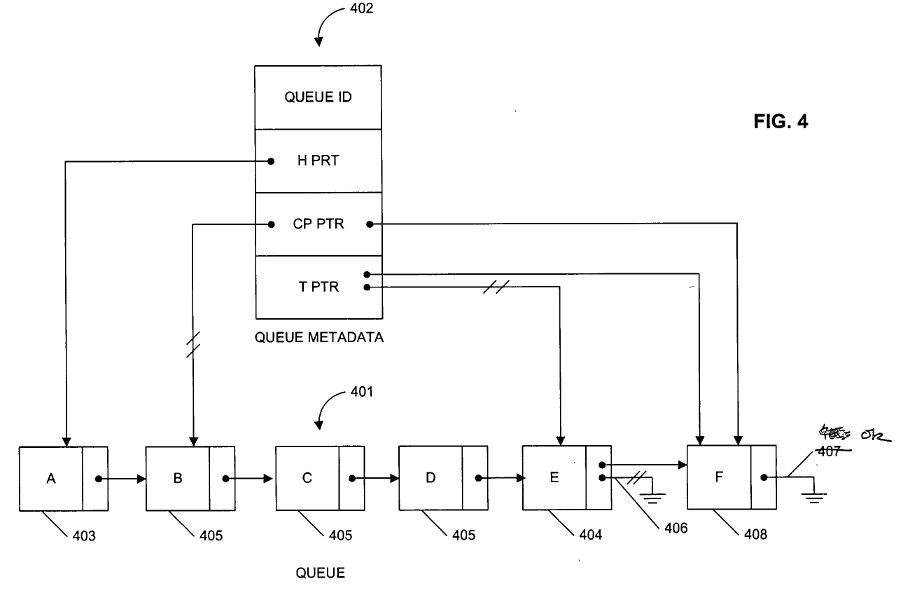

FIG. 4 illustrates an enqueue operation in accordance with an embodiment of the invention. In one embodiment, an enqueue operation comprises adding a new node 408 to the tail end of queue 401, displacing node 404 as the tail end node. A series of pointer readjustments is made to effectuate the update operation. Thus, T PTR is made to point to new node 408. Null pointer 406 of tail node 404 is made to point to new node 408. New node 408 is made to contain a null pointer 407 and is the new tail node of queue 401 at the completion of an enqueue operation.

Dequeue

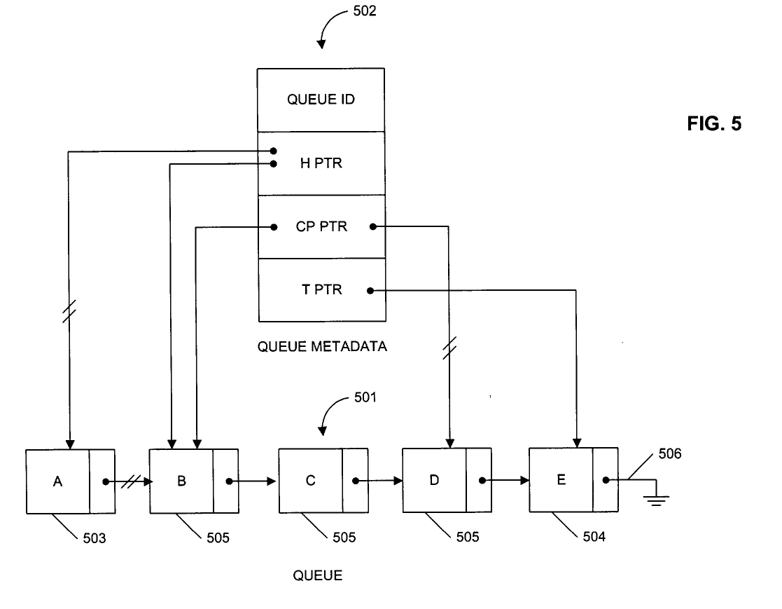

FIG. 5 illustrates a dequeue operation in accordance with an embodiment of the invention. In one embodiment, a dequeue operation comprises removing head node 503 from the head of queue 501, making the first intermediate node 505 the new head node of queue 501. H PTR is readjusted to point to the first intermediate node 505 containing (in this case) data element B.

Update

An update operation is used to make changes to the queue data element pointed to by the CP PTR. For example, in FIG. 3, to change the contents of data element B to B′, an update operation can be invoked to swap data element B′ for data element B because CP PTR is currently pointing to node B. Update operations can be easily performed on any node data element pointed to by a pointer. Thus, head node 303 and tail node 304 are also good update operation candidates.

An update operation changes a data element in a queue without removing a node from the head of the queue. As such, an update to successive nodes in a queue is referred to as a non-destructive dequeue operation. A non-destructive dequeue operation typically increments a pointer, such as CP PTR, as it performs updates element by element. A non-destructive dequeue beginning at the head node is thus capable of performing an update to entire queue 301. Reading data elements from queue 301 as well as performing range scans are also possible. Accessing data elements in a non-destructive fashion can also be used to process nodes in queue 301 from wherever a pointer, such as CP PTR, currently sits and may be processed in either direction. Thus, a non-destructive operation can be used to process entire queue 301, or a portion of queue 301, beginning with a current position pointer. In order to support data element access in both directions, queue 301 is preferably implemented as a doubly linked list.

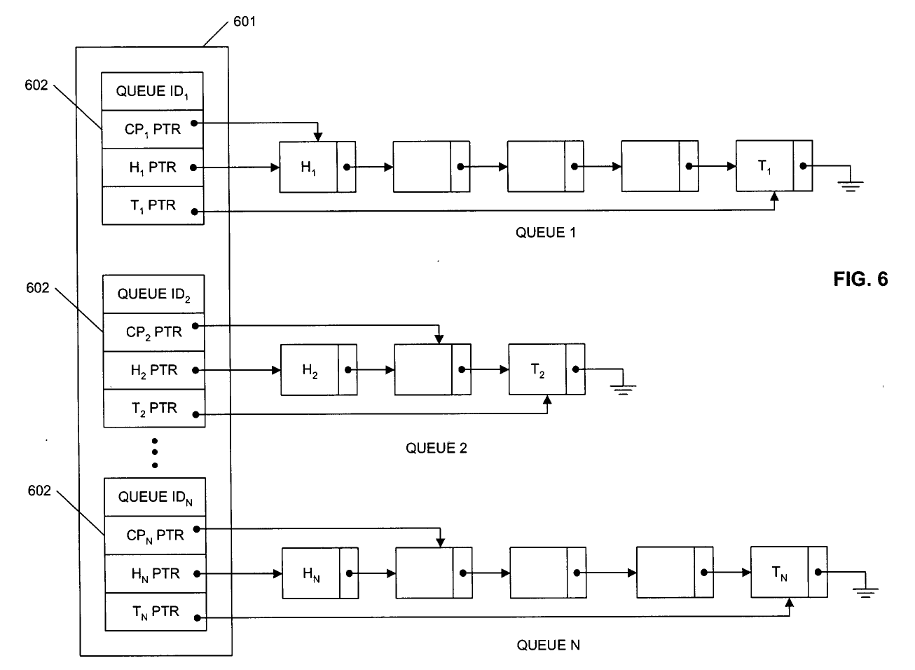

Often an application will require multiple queues. A container object can be used to organize multiple queue metadata objects 302. FIG. 6 is an exemplary block diagram of a container 601 that contains queue metadata objects 602 for multiple queues (i.e., QUEUE 1, QUEUE 2, . . . , QUEUE N) according to an embodiment of the invention. In one embodiment, container 601 is a hash table and queue metadata objects 602 are hash buckets. A hash bucket 602 contains the pointers for a queue, and uniquely defines a link to a queue via a data element known as a queue identifier (QUEUE ID). For instance, QUEUE_ID₁ is a link to the head node H₁ of QUEUE 1. Similarly, QUEUE_ID₂ is a link to the head node H₂ of QUEUE 2, and so forth. In effect, the queue identifier acts as the hash key for hash table 601.

In the hash table embodiment of FIG. 6, hash table 601 relies on a hashing function to locate the hash bucket where a given queue identifier resides. A hash table implementation of container object 601 is advantageous from a performance point of view because hashing supports hash bucket insertion, deletion, and finds in constant average time. Choosing a hash function can be more difficult, however, because many hash functions, such as a system default hash function, may produce collisions. The hashing function should be chosen to avoid collisions if possible.

In one embodiment, the invention is implemented in an RDBMS environment. In such case, data element A contained in node 303, for instance, could be a complete data record that corresponds to a row in a data table. For example, the following SQL statement sample syntax can be used to implement the aforementioned queue structure and properties in a table invoking a SQL CREATE TABLE command for a typical call center application to be discussed in detail below:

CREATE TABLE CALL_QUEUE (

Cust_acct_number
Cust_callback_number
Call type
Call_time_stamp
ORGANIZATION QUEUE(
QUEUE_ID (Call_type)
QUEUE_HASHKEYS 10
QUEUE_HASH_IS (Call_type mod QUEUE_HASHKEYS)
QUEUE_SORTED_BY (Call_time_stamp)

);

The single statement above defines both the table for storing row-data and the queue properties for enabling the systems and methods for queuing data. In the sample table defined by the CREATE TABLE statement above, each row of data will correspond to a call placed to a call center, for instance, a large volume call center for a multinational organization that fields hundreds of customer calls per day. As a practical matter, sample table A represents one of several possible tables in a schema that might implement a scalable solution to an enterprise-wide call center application.

The ORGANIZATION QUEUE clause directs the RDBMs to create a table with queue properties and structure in the manner described with reference to FIG. 6, as explained in detail to follow.

QUEUE_ID

The QUEUE_ID parameter maps one or more row attributes (i.e., table columns) to a hash bucket within hash table 601. Thus, in this example, for each call_type, we can contain one or more rows of call data associated with that call_type. In other words, all incoming calls for technical assistance, for instance, would be contained in a hash bucket for the tech support call type. Other hash buckets could exist to support distinct call_types and their associated queues, such as customer billing inquiries or new accounts.

QUEUE_HASHKEYS

The number of hash values for a hash table is fixed by the QUEUE_HASHKEYS parameter. The value of QUEUE_HASHKEYS limits the number of unique hash values that can be generated by the hash function, with each unique hash value corresponding to a hash bucket 602 in hash table 601. Thus, the QUEUE_HASHKEYS value specifies the number of hash buckets 602 in hash table 601. In another implementation, the number of hash values is not fixed and can be adjusted as needed. QUEUE_HASH_IS

The QUEUE_HASH_IS parameter specifies the hash function to be used in mapping a queue data element, such as a table row, to the hash bucket 602 associated with the QUEUE_ID of that data element. The hash function takes as input a QUEUE_ID for a given data element and returns a hash value corresponding to the hash bucket where the queue resides. In one implementation, a system default hash function can be used if a user or client does not specify a hash function. In another implementation, the user or client can bypass the default hash function and specify one or more columns on which to hash, if the one or more columns already possess uniqueness. The hash function specified in the call center sample syntax may not be ideal for a given application, depending on the collisions that would result.

Because the performance enhancements realized by the present invention depend heavily upon the hash function chosen, a hash function that minimizes collisions is the goal. Ideally, therefore, each hash bucket should map to only one queue identifier. Resolving collisions are possible, but costly, and may cause an unwanted hit to system performance.

QUEUE_SORTED_BY

Because a queue can only be traversed lineally, the order in which data elements are inserted into the queue is important. The columns in the QUEUE_SORTED_BY clause specify the insertion order of the nodes placed in the queue. If the ordering of nodes is violated by the user or an application, the systems and methods for queuing data can send an error message back to the application, or can perform the requested operation with a higher cost.

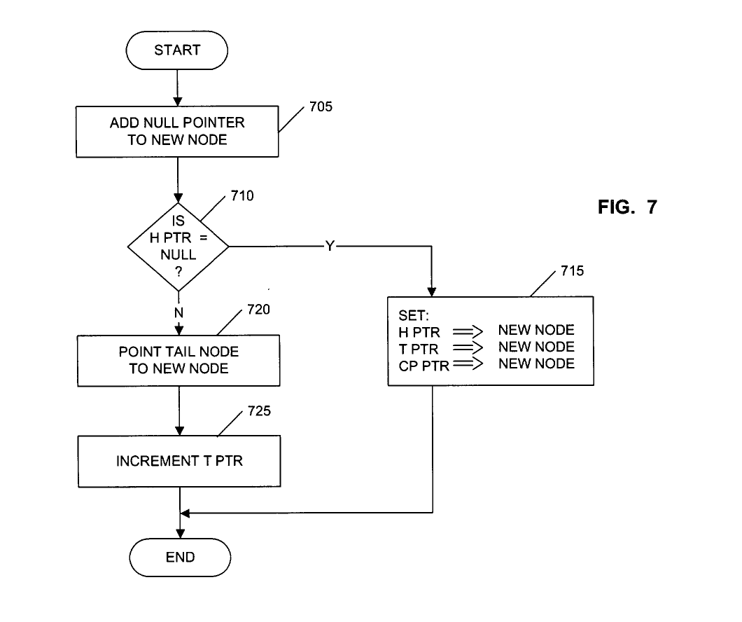

FIG. 7 is a flow diagram illustrating one example enqueue operation in accordance with an embodiment of the invention, as introduced with respect to FIG. 4. In block 705, new node 408 is appended to the tail end of queue 401 by adding null pointer 407 to new node 408. In condition block 710, metadata 402 is checked to determine if H PTR is set to null, as would indicate an empty queue. If queue 401 is empty, then block 715 is invoked to cause H PTR, T PTR, and CP PTR to point to new node 408. If queue 401 is not empty, then in block 720 tail node 404 is made to point to new node 408 and in step 725, T PTR is made to point to new node 408.

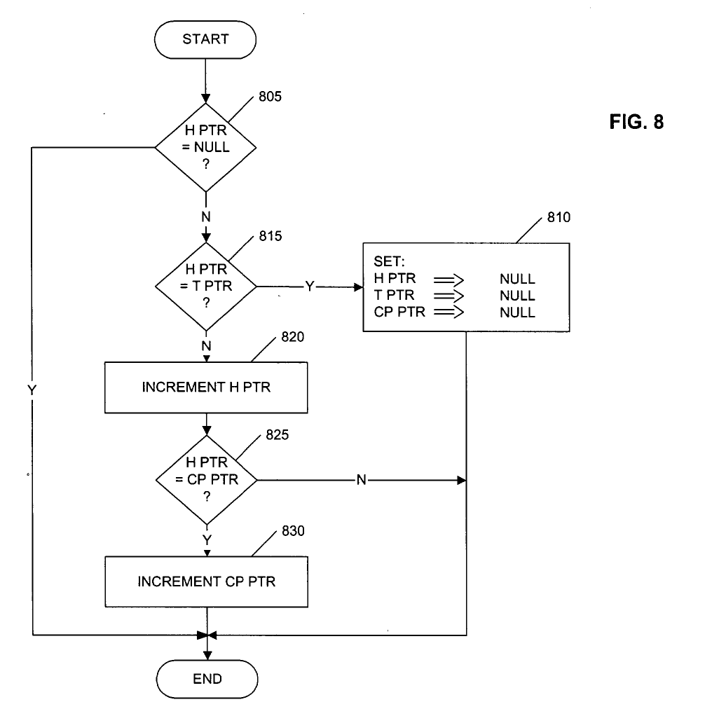

FIG. 8 is a flow diagram illustrating one example dequeue operation in accordance with an embodiment of the invention, as introduced with respect to FIG. 5. In condition block 805, metadata 502 is first checked to determine if the head pointer is set to null, as would indicate an empty queue. If the head pointer is set to null, then the process ends because there is no node to be dequeued. If the head pointer is not empty, and if the head pointer and tail pointer both point to the same node, as would indicate a single-node queue, then block 810 is invoked to set H PTR, T PTR, and CP PTR to point to null. Otherwise, for a queue with greater than one node, H PTR is incremented in step 820 and CP PTR is incremented in step 830 if CP PTR is equal to H PTR in step 825.

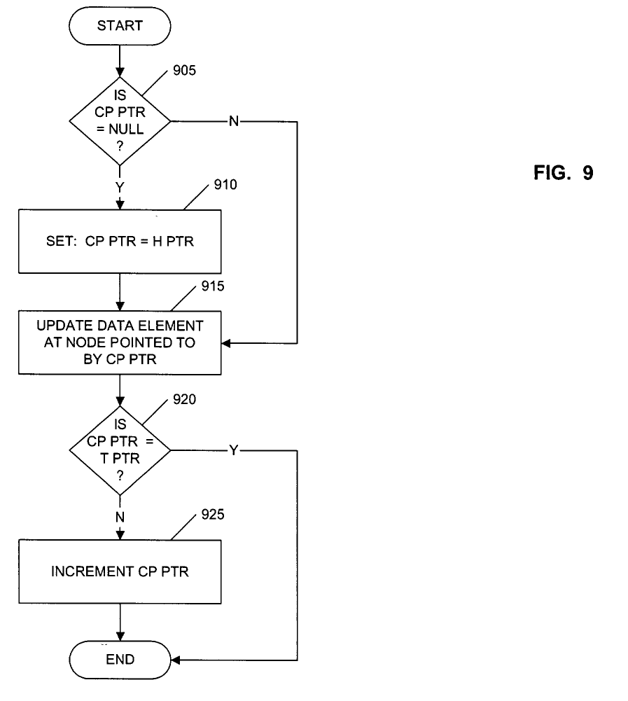

FIG. 9 is a flow diagram illustrating one example update operation in accordance with an embodiment of the invention. In this embodiment, the update operation method is a non-destructive dequeue operation of queue 301. In block 905, if CP PTR is set to null, as would indicate no current position from which to begin the operation, then in step 910, CP PTR is set to point to the node pointed to by H PTR in order to initiate an update beginning from the head of queue 301. If CP PTR is not set to null, then processing continues with block 915. In step 915, the update to the data element contained in the node pointed to by CP PTR occurs. In decision block 920, if CP PTR is pointing to the tail end of queue 301, then the update terminates. If CP PTR is not pointing to the tail end of queue 301 after performing the update, then CP PTR is incremented in step 925.

The systems and methods for queuing data contemplate other implementation features such as SQL command-line parameters readable by the optimizer for performing one-time overrides of the current system parameter configuration. One such command-line construct is a hint. A hint permits a user to influence or override the optimizer's discretion in building an efficient execution plan for a particular statement.

For example, a hint could suggest to the optimizer that the queue operation should begin with the node pointed to by the tail pointer or current position pointer and scan backwards, in descending order. Other hints implemented using this or similar syntax can include starting the scan from the current position pointer and scanning forward, and using a hint-supplied row identifier as the starting position of the scan, to name just a few.

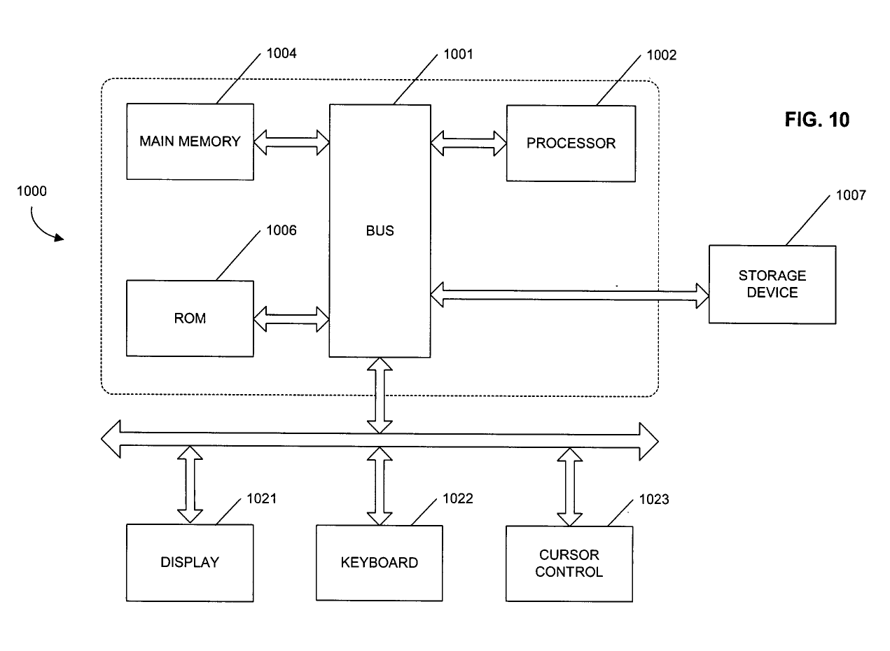

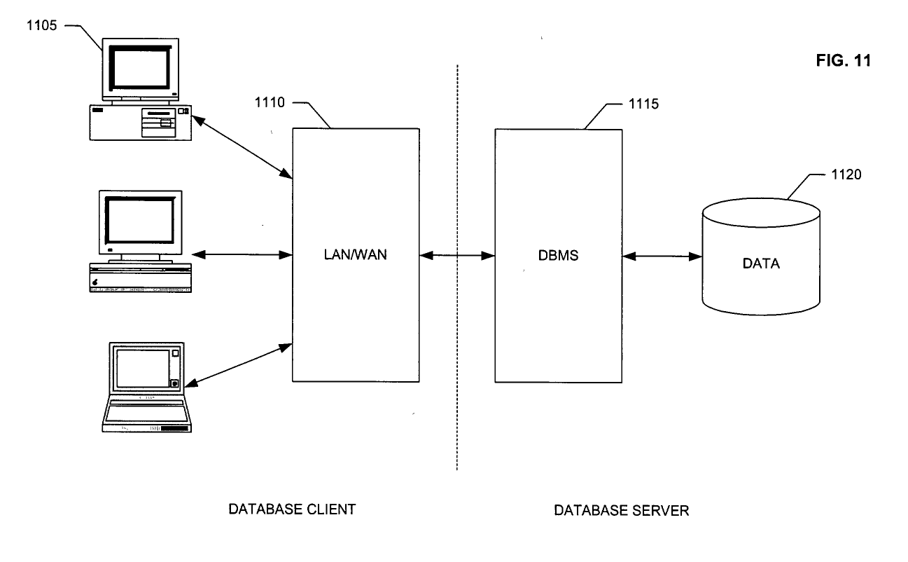

FIG. 10 is a block diagram of a computer system 1000 upon which the systems and methods for queuing data can be implemented. Computer system 1000 includes a bus 1001 or other communication mechanism for communicating information, and a processor 1002 coupled with bus 1001 for processing information. Computer system 1000 further comprises a random access memory (RAM) or other dynamic storage device 1004 (referred to as main memory), coupled to bus 1001 for storing information and instructions to be executed by processor 1002. Main memory 1004 can also be used for storing temporary variables or other intermediate information during execution of instructions by processor 1002. Computer system 1000 also comprises a read only memory (ROM) and/or other static storage device 1006 coupled to bus 1001 for storing static information and instructions for processor 1002. Data storage device 1007, for storing information and instructions, is connected to bus 1001.

A data storage device 1007 such as a magnetic disk or optical disk and its corresponding disk drive can be coupled to computer system 1000. Computer system 1000 can also be coupled via bus 1001 to a display device 1021, such as a cathode ray tube (CRT), for displaying information to a computer user. Computer system 1000 can further include a keyboard 1022 and a pointer control 1023, such as a mouse.

The systems and methods for queuing data can be deployed on computer system 1000 in a stand-alone environment or in a client/server network having multiple computer systems 1000 connected over a local area network (LAN) or a wide area network (WAN). FIG. 11 is a simplified block diagram of a two-tiered client/server system upon which the systems and methods for queuing data can be deployed. Each of client computer systems 1105 can be connected to the database server via connectivity infrastructure that employs one or more LAN standard network protocols (i.e., Ethernet, FDDI, IEEE 802.11) and/or one or more public or private WAN standard networks (i.e., Frame Relay, ATM, DSL, T1) to connect to a database server running DBMS 1115 against data store 1120. DBMS 1115 can be, for example, an Oracle RDBMS such as ORACLE 9i. Data store 1120 can be, for example any data store or warehouse that is supported by DBMS 1115. The systems and methods for queuing data are scalable to any size, from simple stand-alone operations to distributed, enterprise-wide multi-terabyte applications.

In one embodiment the system and methods for queuing data are performed by computer system 1000 in response to processor 1002 executing sequences of instructions contained in memory 1004. Such instructions can be read into memory 1004 from another computer-readable medium, such as data storage device 1007. Execution of the sequences of instructions contained in memory 1004 causes processor 1002 to perform the process steps of the methods described herein. In alternative embodiments, hardwired circuitry can be used in place of or in combination with software instructions to implement the present invention. Thus, the systems and methods for queuing data are not limited to any specific combination of hardware circuitry and software.

The methods and systems for queuing data can be implemented as a direct improvement over existing systems and methods for OLTP, as described herein. However, the present invention also contemplates the enhancement of other DBMS subsystems and interfaces including, by way of example, necessary modifications to one or more proprietary procedural languages, such as Oracle PL/SQL, or code-level adjustments or add-ons to a proprietary or open-system architecture such as Java stored programs, needed to extend the functionality of the present invention. This and other similar code modifications may be necessary to a successful implementation and it is fully within the contemplation of the present invention that such modified or additional code be developed.

What is claimed is:

1. A method for queuing data, comprising:
receiving a record from a database client; and
enqueuing in a queue a node comprising said record.

2. The method of claim 1, wherein enqueuing said node further comprises inserting said node at a tail end of said queue.

3. The method of claim 1, further comprising pointing to a node of said queue with a current position pointer.

4. The method of claim 1, further comprising dequeuing said node.

5. The method of claim 4, wherein dequeuing said node further comprises removing said node from a head of said queue.

6. The method of claim 1, further comprising updating said record.

7. The method of claim 6, further comprising updating a next record in said queue.

8. The method of claim 1, wherein said record is a row in a table.

9. The method of claim 1, further comprising containing said queue in a hash bucket.

10. The method of claim 9, further comprising hashing a queue identifier of said record.

11. A system for queuing data comprising:
one or more queues for storing one or more records; and
one or more metadata objects for storing one or more queue identifiers corresponding to said one or more queues.

12. The system of claim 11, further comprising a container for storing said one or more metadata objects.

13. The system of claim 12, wherein said container is a hash table.

14. The system of claim 11, wherein said one or more metadata objects is a hash bucket.

15. The system of claim 11, wherein said one or more metadata objects further comprises a head pointer to a head end of said queue.

16. The system of claim 11, wherein said one or more metadata objects further comprises a tail pointer to a tail end of said queue.

17. The system of claim 11, wherein said one or more metadata objects further comprises a current position pointer for locating a position in said queue.

18. The system of claim 11, wherein said one or more records is a row in a table.

19. The system of claim 11, wherein said one or more queues is implemented as a linked list.

20. A computer readable medium having stored thereon one or more sequences of instructions for controlling execution of one or more processors, the one or more sequences of instructions comprising instructions for:
receiving a record from a database client; and
enqueuing in a queue a node comprising said record.

21. The computer readable medium of claim 20, wherein enqueuing said node further comprises inserting said node at a tail end of said queue.

22. The computer readable medium of claim 20, the one or more sequences of instructions stored thereon further comprising instructions for pointing to a node of said queue with a current position pointer.

23. The computer readable medium of claim 20, the one or more sequences of instructions stored thereon further comprising instructions for dequeuing said node.

24. The computer readable medium of claim 23, wherein dequeuing said node further comprises removing said node from a head of said queue.

25. The computer readable medium of claim 20, the one or more sequences of instructions stored thereon further comprising instructions for updating said record.

26. The computer readable medium of claim 25, the one or more sequences of instructions stored thereon further comprising instructions for updating a next record in said queue.

27. The computer readable medium of claim 20, wherein said record is a row in a table.

28. The computer readable medium of claim 20, the one or more sequences of instructions stored thereon further comprising instructions for containing said queue in a hash bucket.

29. The computer readable medium of claim 28, the one or more sequences of instructions stored thereon further comprising instructions for hashing a queue identifier of said record.

30. A system for queuing data, comprising:
means for receiving a record from a database client; and
means for enqueuing in a queue a node comprising said record.

31. The system of claim 30, wherein means for enqueuing said node further comprises means for inserting said node at a tail end of said queue.

32. The system of claim 30, further comprising means for pointing to a node of said queue with a current position pointer.

33. The system of claim 30, further comprising means for dequeuing said node.

34. The system of claim 33, wherein means for dequeuing said node further comprises means for removing said node from a head of said queue.

35. The system of claim 30, further comprising means for updating said record.

36. The system of claim 35, further comprising means for updating a next record in said queue.

37. The system of claim 30, wherein said record is a row in a table.

38. The system of claim 30, further comprising means for containing said queue in a hash bucket.

39. The system of claim 38, further comprising means for hashing a queue identifier of said record.
